(19) United States
(12) Patent Application Publication
(10) Pub. No.: US 2001/0018676 A1
(43) Pub. Date: Aug. 30, 2001

(54) Method for compressing stock price data and method for transmitting compressed stock price data

(76) Inventors: Tatsuhide Iida, Tokyo (JP); Kayoko Iida, Tokyo (JP)

Correspondence Address: BIRCH STEWART KOLASCH & BIRCH, PO BOX 747, FALLS CHURCH, VA, 22040-0747, US

(21) Appl. No.: 09/767,956

(22) Filed: Jan. 24, 2001

(30) Foreign Application Priority Data
Jan. 24, 2000 (JP) P2000-014882

(51) Int. Cl. G06F 17/60

(52) U.S. Cl. 705/36

(57) ABSTRACT

This invention provides a compression method of stock price data, capable of greatly reducing a total byte number which is required so as to process stock price data. While an attention is paid to a stock dealing volume and a relationship among a starting value, a high value, a low value, and a closed value, which may occur in the security trading, two sorts of classifications are previously set, and also each of these two classifications is further previously subdivided into a plurality of patterns. Also, classification identification data which pattern of the respective classifications a set of the stock price data belongs to is used.

### BACKGROUND OF THE INVENTION

1. Field of the Invention

This invention relates to a compression method of stock price data, capable of effectively compressing stock price data, and also a method for transmitting compressed stock price data.

2. Description of the Prior Art

Various security trading services known as a so-called “home trade” service and/or a so-termed “on-line trade” service have been commenced. That is, in the above-described security trading services, while investors connect terminal units such as personal computers via communication lines to host computers of securities firms, these investors may establish security dealings. Also, the following environments may be gradually established. That is, investor may readily acquire via the Internet such information as stock price data and financial indexes, which will constitute judgment materials required for security dealings. Normally, stock price data which are provided from securities firms or the like to investors include such data which contain security codes, stock names (firm names), date, starting prices, high prices, low prices, closed prices, and stock dealing volumes of stocks, trades of which are established in stock markets.

At the current time, as stock names listed in Japanese stock markets, there are approximately 3,400 firms. The total number of these listed stock names is increased year by year. As a consequence, considering now to such a case that all stock price data as to all of these stock names are transmitted within one time from a single host computer to terminal units owned by a large number of investors, while users are increased, data amounts which should be processed and/or transmitted are considerably increased. As a result, work loads given to this single host computer and communication lines are increased.

Now, the following case is considered: While an attention is paid to a starting price, a high price, a low price, a closed price, and a volume among stock price data, these data are transmitted in a variable length manner by employing the ASCII code (American Standard Code for Information Interchange). As one example, it is so assumed that a starting price of a certain stock name, a high price thereof, a low price thereof, a closed price thereof, and a volume thereof are given as 100 yen, 110 yen, 98 yen, 110 yen, and 234,000 stocks, respectively. Assuming again that this stock price data is described as text data defined as “100, 110, 98, 110, 234”, 19 bytes are required in total, while 3 bytes are allocated to the respective numeral values; 1 byte is allocated to commas which are used to segment the respective numeral values; and furthermore, 1 byte is allocated so as to indicate a segment of data for every stock name. Similarly, as to another stock name, it is so assumed that a starting price of this stock name, a high price thereof, a low price thereof, a closed price thereof, and a volume thereof are given as 1234 yen, 1289 yen, 1234 yen, 1256 yen, and 4,567,000 stocks, respectively. Assuming again that this stock price data is described as text data defined as “1234, 1289, 1234, 1256, 4567”, 25 bytes are required in a similar manner.

Next, the following case is considered: That is, similar stock data is transmitted in a fixed length manner by employing a binary code. A range of numerals which can be handled as 1 byte is defined by 0 to 255, whereas a range of numerals which can be handled as 2 bytes is defined by 0 to 65535. Normally, it is conceivable that 4 bytes are required in order to firmly process stock prices having various numerals values. However, in a similar expression manner employing a preselected digit notation (unit price of 100 yen, unit price of 1000 yen, etc.) in a stock market column of a newspaper, if numeral values are processed in accordance with a specifically defined rule, then most of stock price data may be handled by using 2 bytes. As a result, assuming now that 2 bytes are allocated to a starting price, a high price, a low price, and a closed price, respectively, with respect to a certain stock name, whereas 4 bytes are allocated to a volume thereof in view of a safety expression aspect, this stock price data will constitute fixed-length data having 12 bytes in total. For instance, assuming now that the above-explained two examples of stock price data as to “100, 110, 98, 110, 234” and “1234, 1289, 1234, 1256, 4567” are expressed by employing the binary code, the below-mentioned table 1 may be obtained.

TABLE 1

| byte | 1 | 2 | 3 | 4 | 5 | 6 | 7 | 8 | 9 | 0 | 11 | 12 |
|---|---|---|---|---|---|---|---|---|---|---|---|---|
| decimal | 100 | | 110 | | 98 | | 110 | | 234 | | | |
| notation | | | | | | | | | | | | |
| hexadecimal | 00 | 64 | 00 | 6E | 00 | 62 | 00 | 6E | 00 | 00 | 6A | 88 |
| notation | | | | | | | | | | | | |
| byte | 1 | 2 | 3 | 4 | 5 | 6 | 7 | 8 | 9 | 0 | 11 | 12 |
| decimal | 1234 | | 1289 | | 1234 | | 1256 | | 4587 | | | |
| notation | | | | | | | | | | | | |
| hexadecimal | 04 | D2 | 05 | 09 | 04 | D2 | 04 | E8 | 00 | B8 | 0E | 8D |
| notation | | | | | | | | | | | | |

As previously explained, when the starting price, the high price, the low price, and the closed price of the stock name, and also the volume of the stock dealings are processed by employing the conventional data format, 12 bytes are necessarily required even in minimum as to a single stock name.

### SUMMARY OF THE INVENTION

Therefore, an object of the present invention is to provide a compression method of stock price data, capable of greatly reducing a total byte number which is required so as to process stock price data by employing the following manner. That is, while an attention is paid to both a value of stock dealing volumes and a relationship among values which may be produced in a security trading market, i.e., starting prices, high prices, low prices, and closed prices of stocks, two different classifications are previously set. Each of these two classifications is previously subdivided into a plurality of patterns. Then, classification identification data is used so as to identify as to which pattern contained in each of these classifications a set of stock price data belongs to. Another object of the present invention is to provide a transmission method of compressed stock price data, capable of largely reducing a data amount in such a case that a plurality of stock price data are transmitted in a batch mode from a host computer via a communication line to terminal units.

To achieve the above-explained objects, a compression method of stock price data, according to an aspect of the present invention, is featured by such a compression method of stock price data, wherein:

while two sorts of classifications are previously set based upon a volume of stock dealings and a relationship among values of a starting price, a high price, a low price, and a closed price, which may occur in security trading in a stock market, the first classification is previously subdivided into “n” sorts (symbol “n”<16) of patterns in accordance with a high/low/same value relationship among the starting price, the high price, the low price, and the closed price, and the second classification is previously subdivided into “m” sorts (symbol “m”<16) of patterns in accordance with the low price, a difference between the high price and the low price, the stock dealing volume, and a digit notation; the compression method comprising the steps of:

entering one piece of stock price data which contains at least numeral value data (S, H, L, E, T,) related to the starting price, the high price, the low price, the closed price, and the stock dealing volume;

identifying as to which pattern of the first classification the entered stock price data belongs to thereby producing first classification information indicative of the identified pattern;

identifying as to which pattern of the second classification the entered stock price data belongs to thereby producing second classification information indicative of the identified pattern;

combining the produced first classification information with the produced second classification information thereby producing one piece of classification identification data “C”;

extracting numeral data “L” of the low price from the stock price data;

producing numeral data D₁ of a difference between the starting price and the low price (D₁=S−L), numeral data D₂ of a difference between the high price and the low price (D₂=H−L), and numeral data D₃ of a difference between the closed price and the low price (D₃=E−L), based upon the stock price data; in the case that there are “K” pieces (symbol “K”=2, 3, or 4) of the same values among the numeral data as to the starting price, the high price, the low price, and the closed price, extracting (4−K) pieces of different numeral data “D₄” from the numeral data D₁, D₂, D₃;

extracting numeral data “T” of the stock dealing volume from the stock price data; and

producing binary data related to stock price data of one stock name from the produced classification identification data “C”, the extracted numeral data “L” of the low price, the (4−K) pieces of different numeral data “D₄”, and the numeral data “T” of the stock dealing volume.

In addition, a transmission method of compressed stock price data, according to another aspect of the present invention, is featured by such a transmission method of compressed stock price data, wherein:

while two sorts of classifications are previously set based upon a volume of stock dealings and a relationship among values of a starting price, a high price, a low price, and a closed price, which may occur in security trading in a stockmarket, the first classification is previously subdivided into “n” sorts (symbol “n”<16) of patterns in accordance with a high/low/same value relationship among the starting price, the high price, the low price, and the closed price, and the second classification is previously subdivided into “m”, sorts (symbol “m”<16) of patterns in accordance with the low price, a difference between the high price and the low price, the stock dealing volume, and a digit notation; the transmission method comprising the steps of:

entering one piece of stock price data which contains at least numeral value data (S, H, L, E, T,) related to the starting price, the high price, the low price, the closed price, and the stock dealing volume;

identifying as to which pattern of the first classification the entered stock price data belongs to thereby producing first classification information indicative of the identified pattern;

identifying as to which pattern of the second classification the entered stock price data belongs to thereby producing second classification information indicative of the identified pattern;

combining the produced first classification information with the produced second classification information thereby producing one piece of classification identification data “C”;

extracting numeral data “L” of the low price from the stock price data;

producing numeral data D₁ of a difference between the starting price and the low price (D₁=S−L), numeral data D₂ of a difference between the high price and the low price (D₂=H−L), and numeral data D₃ of a difference between the closed price and the low price (D₃=E−L), based upon the stock price data, in the case that there are “K” pieces (symbol “K”=2, 3, or 4) of the same values among the numeral data as to the starting price, the high price, the low price, and the closed price, extracting (4−K) pieces of different numeral data “D₄” from the numeral data D₁, D₂, D₃;

extracting numeral data “T” of the stock dealing volume from the stock price data;

producing binary data related to stock price data of one stock name from the extracted numeral data “L” of the low price, the (4−K) pieces of different numeral data “D₄”, and the numeral data “T” of the stock dealing volume;

carrying out the data compression to the binary data with respect to stock price data of a plurality of stock names;

while the classification identification data “C” is used as a key, producing a plurality of groups of binary data having the same data from the compressed stock price data of the plurality of stock names;

adding the classification identification data “C” corresponding to the group to a head of each of the groups as binary data; and

transmitting the resulting binary data from a host computer via a communication line to at least one terminal unit in a batch mode.

### BRIEF DESCRIPTION OF THE DRAWINGS

The invention will be explained in more detail in conjunction with appended drawings, wherein:

FIG. 1 is a flow chart showing a process flow operation of a compression method of stock price data, according to the present invention;

FIG. 2 is a flow chart showing a summary of an example of a process operation executed in the case that after a host computer compress-processes stock price data, the host computer transmits the compressed stock price data to a terminal unit; and

FIG. 3 is a flow chart showing a summary of an example of a process operation executed in the case that the compressed stock price data which has been processed by the compression-process shown in FIG. 2 and then transmitted from the host computer is received by the terminal unit so as to be expanded.

### DETAILED DESCRIPTION OF THE PREFERRED EMBODIMENTS

Referring now to drawings, preferred embodiments of the present invention will be described. It should be noted that the present invention is not limited to the below-mentioned embodiments, but may be modified within the technical spirit and scope of the present invention as defined in the accompanying claims.

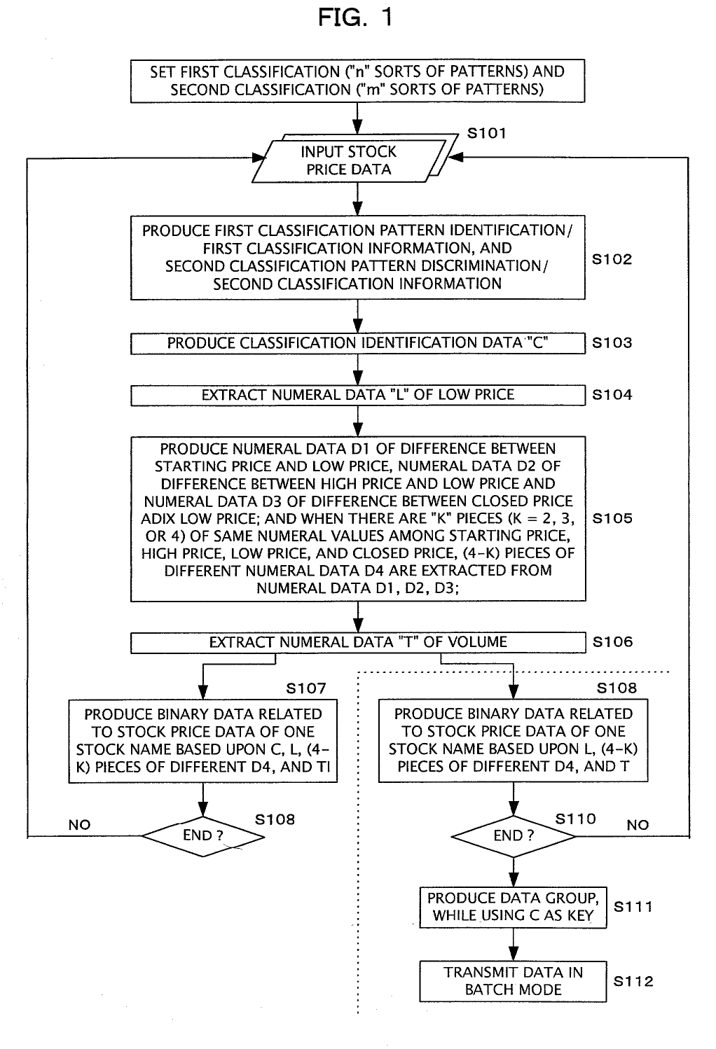

FIG. 1 shows a process flow operation as to a compression method of stock price data, according to the present invention. This stock price data compressing method will now be sequentially explained.

1) Two sorts of classifications are previously set based upon a value of stock dealing volume and a relationship among values which may be produced in security trading, namely, a starting price, a high price, a low price, and a closed price of a stock name. The first classification is previously subdivided into “n” sorts (symbol “n” <16) of patterns based upon relationships of high/low/same values with respect to the starting price, the high price, the low price, and the closed price of the stock name. On the other hand, the second classification is previously subdivided into “m” sorts (symbol “m” <16) of patterns based on the low price of the stock name, a difference between the high price and the low price, the volume of stock dealings, and a digit notation.

2) Subsequently, one piece of stock price data is entered (step S101). This stock price data contains at least numeral data (S, H, L, E, T) which relates to the starting value, the high value, the low value, the closed value of the stock name, and the volume of stock dealings, respectively.

3) An identification is made as to which pattern of the first classification the entered stock price data belongs to, and then, first classification information indicative of this identified pattern is produced. Furthermore, another identification is made as to which pattern of the second classification this entered stock price data belongs and then second classification information indicative of this identified pattern is produced (step S102).

4) Next, the produced first classification information is combined with the produced second classification information to thereby produce one piece of classification identification data “C” (step S103).

5) The numeral data “L” of the low price is extracted from the stock price data (step S104).

6) Based upon the stock price data, numeral data D₁ of a difference between the starting price and the low price (D₁=S−L) is produced; numeral data D₂ of a difference between the high price and the low price (D₂=H−L) is produced; and numeral data D₃ of a difference between the closed price and the low price (D₃=E−L) is produced. In such a case that there are “K” pieces (K=2, 3, or 4) of same values among the numeral value data as to the starting price, the high price, the low price, and the closed price, (4−K) piece of different numeral data D₄ are extracted from numeral data D₁, D₂, and D₃ (step S105).

7) The numeral data “T” of the volume of stock dealings is extracted from the stock price data (step 106).

8) Binary data related to stock price data of a single stock name is produced from the produced classification identification data C, the extracted numeral data L of the low price, the (4−K) pieces of different numeral data D₄, and the numeral data T of the volumes of stock dealings (step S107). The process operation defined from the above-described step S101 to step S107 may be repeatedly carried out with respect to, for example, stock price data of all stock names (step S108).

Next, the meanings of employing a series of the above-explained process operations in the compression method of the stock price data according to this embodiment mode will now be explained as follows:

As a first trend in an actual stock price, there are many cases that two, or more identical values are present among any of a starting price, a high price, a low price, and a closed price of the actual stock price. The following stock names are involved at higher frequencies in stock trading within one day, namely, a stock name whose four values (starting/high/low/closed prices thereof) are identical to each other, and also another stock name whose starting price is identical to the high price thereof, and whose low price is identical to the closed price thereof. If a plurality of the same numeral values are repeatedly and directly transmitted, then the efficiency of the stock data transmission is lowered. Therefore, in accordance with the present invention, while an attention is paid to this first trend, the first classification is previously subdivided into “n” sorts (n<16) of patterns as shown in the following table 2 based upon such a relationship among high/low/same values as to the starting price, the high price, the low price and the closed price:

TABLE 2
PATTERNS SUBDIVIDED FROM FIRST CLASSIFICATION

| | high/low/same value | | |
|---|---|---|---|
| | relationship among | | |
| | starting prices S, high | | total number |
| pattern | price H, low price L, | patterns having | of original |
| NO. | and closed price E | same values | numeral data |
| 1 | no stock dealing (namely, | — | NONE |
| | stock dealing could not be | | |
| | established, and no data) | | |
| 2 | S = H = L= E | 4 numeral values | 1 |
| | | are same | |
| | | 3 numeral values | |
| 3 | S = H, H = E, L < E | are same, and only | 2 |
| | | low price is low | |
| | | 3 numeral values | |
| 4 | S = L, L = E, H > E | are same, and only | 2 |
| | | high price is high | |
| 5 | S = J, H = E, S < E | same numeral | |
| | | values are 2 sets | 2 |
| 6 | S = H, L = E, S > E | same numeral | |
| | | values are 2 sets | 2 |
| 7 | S = H, S > E, E > L | same numeral value | 3 |
| | | is 1 set | |
| 8 | S = L, S < E, E < H | same numeral value | 3 |
| | | is 1 set | |
| 9 | S < H, S > E, E = S | same numeral value | 3 |
| | | is 1 set | |
| 10 | S > L, S > E, E = H | same numeral value | 3 |
| | | is 1 set | |
| 11 | S > L, S = E, E < H | same numeral value | 3 |
| | | is 1 set | |
| 12 | S > L, S < E, E < H | four numeral | 4 |
| | | values are | |
| | | different from | |
| | | each other | |
| 13 | S < H, S > E, E > L | four numeral | 4 |
| | | values are | |
| | | different from | |
| | | each other | |
| 14 | (spare) | | |
| 15 | | | |

The pattern 1 to the pattern 13 indicated in the table 2 cover all of the combinations as to the high/low/same values relationship among the starting prices, the high prices, the low prices, and the closed prices. It should be noted that both the pattern 14 and the pattern 15 are used as spares.

As a second trend in an actual stock price, a considerable amount of stock names having low (cheap) stock prices (numeral values are smaller than, or equal to 255) are continuously present, as viewed in a long term, although there are terms in which a large amount, and a small amount of stock names with cheap stock prices are present. In the case that a stock name owns such stock price data, 1 byte may be allocated with respect to this stock name.

Also, as a third trend in an actual stock price, there are many cases that a difference (price difference) between a high price and a low price is smaller than, or equal to a constant value. Numeral values of four stock price data are always located within a range between a high price and a low price. However, in an actual case, there is high probability where a price difference is smaller than, or equal to 255. There are two reasons. As a first reason, this is because an allowable change difference in stock trading per one day is restricted by a so-called “restricted price difference” rule specifically introduced in a stock market where security trading is carried out. As a second reason, this is because a large number of the following cases may occur. That is a change difference of a actual stock price may be converged to a price difference smaller than the restricted price difference. In this case, the above-explained “restricted price difference” corresponds to the below-mentioned rule.

Restricted Price Difference

While prices of stocks may be determined based upon a so-called supply and demand rule, there is no such a case that one stock having a price of 500 yen yesterday is suddenly changed into a stock price of 100 yen today. This is because in order to avoid confusions as to not only individual investors but also entire stock markets, a limination called as “restricted price difference” is introduced in stock price change ranges. Up to October in 1999 in Japan, the above-explained “restricted price difference” which has been set in the Japanese stock markets is described in the below-mentioned table 3. It should be noted that decisions of “restricted price difference” are made by sponsors of respective stock markets. While this restricted price difference may be temporarily reduced, this restricted price difference is never extended.

TABLE 3
RESTRICTED PRICE DIFFERENCE

| reference stock price/ | reference stock price/ | reference stock price/ |
|---|---|---|
| restricted price | restricted price | restricted price |
| difference | difference | difference |
| less than 100 yen/ | less than 5000 yen/ | less than 1 million yen/ |
| 30 yen | 500 yen | 0.1 million yen |
| less than 200 yen/ | less than 10000 yen/ | less than 1.5 millions |
| 50 yen | 1000 yen | yen/0.2 millions yen |
| less than 500 yen/ | less than 30000 yen/ | less than 2 millions yen/ |
| 80 yen | 2000 yen | 0.3 millions yen |
| less than 1000 yen/ | less than 50000 yen/ | less than 3 millions yen/ |
| 100 yen | 3000 yen | 0.4 millions yen |
| less than 1500 yen/ | less than 100000 yen/ | less than 5 millions yen/ |
| 200 yen | 5000 yen | 0.5 millions yen |
| less than 2000 yen/ | less than 200000 yen/ | less than 10 millions yen/ |
| 300 yen | 50000 yen | 1 million yen |
| less than 3000 yen/ | less than 500000 yen/ | more than, or equal to 10 |
| 400 yen | 80000 yen | millions yen/2 millions |
| | | yen |

In the table 3, assuming now that a stock price (=reference stock price) on a certain day is 150 yen, since this stock price corresponds to “less than 200 yen” in the table 3, a numeral value of “50 yen” on the right side thereof is understood as “restricted price difference” of this stock name. As a consequence, the stock price of this stock name must be present within a range of “150 yen±50 yen” on the next day. In other words, this stock price of tomorrow should be located within such a range defined from 100 yen (minimum) to 200 yen (maximum).

As previously explained, in stock columns of newspapers, the stock prices of high price stock firms are expressed by using preselected digit notations. Such stock price digit notations are the justified expression method which is established in accordance with a so-called “calling value unit” of the Japanese security trading rule. This “calling value unit” corresponds to the minimum change unit (minimum variation unit) employed in the security trading, which is determined in correspondence with the stock price. For instance, a stock name having a stock price of 200 yen may be changed into 201 yen, or 202 yen, whereas another stock name having a stock price of 6000 yen is not changed into 6001 yen, or 6002 yen. However, this stock price of 6000 yen is increased to 6010 yen. That is, the minimum change unit of this stock price becomes 10 yen. In accordance with the present invention, since a method of handling stock price data is employed, which is established in correspondence with this expression method, magnitudes (sizes) of numeral data could be suppressed smaller than, or equal to 255. To this end, such digit notations of 10 yen, 100 yen, 1000 yen, and 10000 yen are utilized.

Assuming now that numeral data of a low stock price exceeds 255, this numeral data can no longer be handled by employing 1 byte. However, while an attention is paid to the above-explained third trend, the following fact may be revealed. That is, even when the numeral data of the low stock price requires 2 bytes so as to be expressed, other three numeral data may be handled by using 1 byte by using such a manner that while the numeral data of the low stock price is used as a reference value, three numeral data of a starting price, a high price, and a closed price are expressed as differences between this reference value and these three stock prices, namely, (starting price− low price), (high price−low price), and (closed price−low price).

For example, it is now assumed that a starting price=2340 yen, a high price=2450 yen, a low price=2230 yen, and a closed price=2320 yen, the following expression may be made: The low price= 2230 yen, the starting price=low price+110 yen, the high price= low price+220 yen, and the closed price=low price+90 yen. In other words, as apparent from the foregoing description, if the numeral data related to the starting price, the high price, and the closed price are expressed by employing these difference amounts, then the necessary byte number can be reduced. As a consequence, the following numeral data are produced based upon the stock price data, namely, numeral data D₁ of a difference between the starting price and the low price (D₁=S−L), numeral data D₂ of a difference between the high price and the low price (D₂=H−L), and numeral data D₃ of the difference between the closed price and the low price (D₃=E−L).

Next, as a fourth trend in an actual stock price, there are many cases that a volume of stock dealings is smaller than a constant value. Although a maximum value of stock dealing volumes per se is very large, stock dealing volumes of most of stock names are unexpectedly small.

In accordance with the present invention, while an attention is paid to the second trend through the fourth trend, the second classification is subdivided into “m” sorts (m<16) of patterns indicated in the below-mentioned table 4 based upon a low price of a stock price, a difference between a high price thereof and this low price, a volume of stock dealing, and a digit notation.

TABLE 4
PATTERNS SUBDIVIDED FROM SECOND CLASSIFICATION

| | | difference | | | |
|---|---|---|---|---|---|
| | | between high | | digit | |
| | | price H | volume | notation | |
| pattern | low | and low | T(× 1000 | of stock | expression of |
| No. | price | price L | stocks) | price | numeral data |
| 1 | L < 256 | (H-L) < 256 | T < 256 | unit of | all numeral data |
| | | | | 1 yen | are expressed by |
| | | | | | 1 byte |
| 2 | L < 256 | (H-L) < 256 | T < 65536 | unit of | numeral data are |
| | | | | 1 yen | expressed by 1 |
| | | | | | byte except for |
| | | | | | volume |
| 3 | L > 255 | (H-L) < 256 | T < 256 | unit of | numeral data are |
| | | | | 1 yen | expressed by 1 |
| | | | | | byte except for |
| | | | | | low price |
| | | | | | numeral data are |
| 4 | L > 255 | (H-L) < 256 | T < 65536 | unit of | expressed by 1 |
| | | | | 1 yen | byte except for |
| | | | | | volume |
| 5 | L > 255 | (H-L) < 256 | T < 65536 | unit of | numeral data are |
| | | | | 10 yen | expressed by 1 |
| | | | | | byte except for |
| | | | | | low price and |
| | | | | | volume |
| 6 | L < 256 | (H-L) < 256 | T < 256 | unit of | all numeral data |
| | | | | 100 yen | are expressed by |
| | | | | | 1 byte |
| 7 | L > 255 | (H-L) < 256 | T < 65536 | unit of | numeral data are |
| | | | | 1000 | expressed by 1 |
| | | | | yen | byte except for |
| | | | | | low price and |
| | | | | | volume |
| 8 | L > 255 | (H-L) < 256 | T < 65536 | unit of | numeral data are |
| | | | | 10000 | expressed by 1 |
| | | | | yen | byte except for |
| | | | | | low price and |
| | | | | | volume |

| | | |
|---|---|---|
| 9 | patterns other than above patterns 1 to 8 | each numeral data |
| | | is expressed by |
| | | maximum bytes |
| | | (3 bytes) |
| 10-15 | (spare) | |

An identification is made as to which pattern of the first classification the stock price data to be processed belongs, and then first classification information indicative of this identified pattern (namely, pattern number of above table 1) is produced. Furthermore, another identification is made as to which pattern of the second classification this stock price data belongs to, and then second classification information representative of this identification pattern (namely, pattern number of above table 3) is produced. Since the values of the above-explained first and second classification information are smaller than 16 as to the pattern number, while the first classification information is combined with the second classification information so as to produce one piece of classification identification data C, if 2 digits obtained when this classification identification data C is expressed by employing the hexadecimal notation are allocated to the respective first/second classification information, then both of the first/second classification information may be expressed by 1 byte.

For instance, in the case that the first classification information is “3” and the second classification information is “5”, the classification identification data “C” may be expressed as “35_{(H)}.” Also, in the case that the first classification information is “10” and the second classification information is “8”, the classification identification data “C” may be expressed as “A8_{(H)}.”

As previously described, it is inefficient that a plurality of the same numeral values are repeatedly transmitted without any modification. In such a case that “K” pieces (K=2, 3, or 4) of the same numeral values exist among the numeral data as to the starting price, the high price, and the closed price, (4−K) pieces of different numeral data “D₄” are extracted from the numeral data D₁, D₂, and D₃, so that the repetition of such data can be avoided.

Finally, binary data related to stock price data of one stock name is produced from the produced classification identification data “C”, the extracted numeral data “L” of the low value, (4−K) pieces of different numeral data “D₄” and the numeral data “T” of the stock dealing volume.

As an example, the following case will now be considered, in which stock price data identical to that shown in the table 1 is compressed.

In a first case of “100, 110, 98, 110, and 234”, the first classification becomes the pattern 10 since the high price of the stock is the same as the closed price thereof, and the second classification becomes the pattern 1 whose numeral value is small. On the other hand, in a second case of “1234, 1289, 1234, 1256, and 4567”, the first classification becomes the pattern 8 since the starting price of the stock is the same as the low price thereof, and the second classification becomes the pattern 4. As a result, the respective data may be constituted by employing 5-byte data and 7-byte data as follows:

TABLE 5

| byte | 1 | 2 | 3 | 4 | 5 |
|---|---|---|---|---|---|
| decimal | 161 | 98 | 2 | 12 | 234 |
| notation | A1 | 62 | 02 | 0C | EA |
| hexadecimal | | | | | |
| notation | | | | | |
| description | classification | low | starting | high price | volume |
| | | | | and closed | |
| | | | | price | |

| byte | 1 | 2 | 3 | 4 | 5 | 6 | 7 |
|---|---|---|---|---|---|---|---|
| decimal | 132 | 1234 | | 55 | 22 | 4567 | |
| notation | | | | | | | |
| hexadecimal | 84 | 04 | D2 | 37 | 16 | D7 | 11 |
| notation | | | | | | | |

| | | | | | |
|---|---|---|---|---|---|
| description | classification | low price | high | closed | volume |
| | | and | price | price | |
| | | starting | | | |
| | | price | | | |

There are many cases that with respect to the stock price data of a plurality of stock names, which have been compressed in the above-described manner, either a portion of these compressed stock price data or all of these compressed stock price data are transmitted in the batch mode. As one of the methods for transmitting the stock price data in the batch mode, there is such a method for transmitting the compressed stock price data of the plurality of stock names in a continuous manner.

For example, in the case that stock price data of 3400 stock names (will be referred to as “a stock name 1 through a stock name 3400” hereinafter) of a certain date are transmitted in a batch mode, as a general data transmission method, the following data transmission method may be employed. That is, stock price data which have been simply compressed by way of the data compression method according to the present invention are transmitted in the form of a data stream. When the information contained in this data stream is listed up, the following will be given:

“stock name 1: first classification is pattern 2, second classification is pattern 6, and the respective numerals are, ______,

stock name 2: first classification is pattern 3, second classification is pattern 4, and the respective numerals are, ______,

stock name 3399: first classification is pattern 5, second classification is pattern 8, and the respective numerals are, ______,

stock name 3400: first classification is pattern 3, second classification is pattern 2, and the respective numerals are, ______.”

However, in the case that the above-explained stock price data is rearranged by another data stream and thereafter the resulting stock price data stream is transmitted, the data amount can be further reduced. In other words, in this another stock price data transmission method, after the stock price data are grouped by way of two classifications of patterns, the grouped stock price data containing the following information are transmitted.

“Thereafter, stock names are continued in which the first classification is pattern 1 and the second classification is pattern 1,

stock name 5: respective numerals values are, ______,

stock name 6: respective numeral values are, ______,

Thereafter, stock names are continued in which the first classification is pattern 1 and the second classification is pattern 2,

stock name 13: respective numeral values are, ______,

stock name 22: respective numeral values are, ______.

Thereafter, stock names are continued in which the first classification is pattern 13 and the second classification is pattern 9,

stock name 25: respective numeral values are, ______,

stock name 1300: respective numeral values are, ______.

To realize the above-explained alternative stock data transmission method, the above-described data compression processing operations subsequent to the step 8) (S107) are replaced by the below-mentioned process operations.

8′) Based upon the extracted numeral data “L” of the low price, (4−K) pieces of different numeral data “D₄”, and the numeral data “T” of the stock dealing volume, binary data is produced which is related to stock price data of one stock name (step S109). Then, with respect to stock price data as to a plurality of stock names, the above-explained compression processing operation for the above-described binary data is carried out (step S110).

9) Subsequently, while the above-explained classification identification data C is employed as a key, a plurality of groups of binary data having the same data are produced from the compressed stock price data of the plurality of stock names. The classification identification data “C” corresponding to the group is added as the binary data to a head of each group (step S111).

10) Finally, the binary data thus produced in such a manner are transmitted from the host computer via the communication line to at least one terminal unit (step S112).

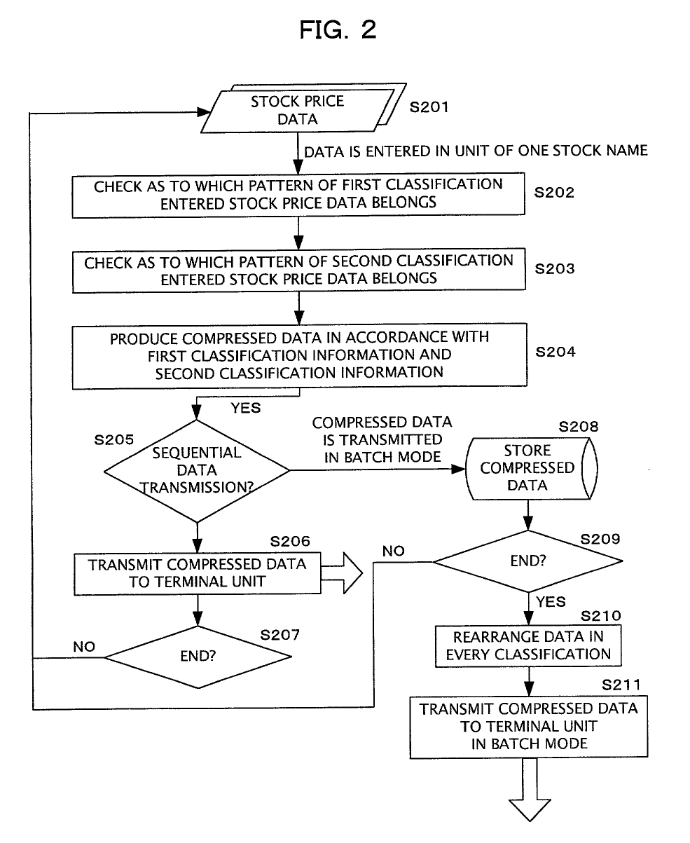

FIG. 2 is a flow chart for describing a summary of an example of a process operation executed in such a case that after a host computer compresses stock price data, this host computer transmits the compressed stock price data to a terminal unit.

First, stock price data is entered in the unit of one stock name (step S201). A check is made as to which pattern of the first classification the entered stock price data belongs to based upon a high/low/same value relationship among a starting price, a high price, a low price, and a closed price with respect to the entered stock price data (step S202). Subsequently, another check is done as to which pattern of the second classification the entered stock price data belongs to based on the low price of this entered stock price, a difference between the high price and the low price, a stock dealing volume, and a digit notation thereof (step S203). Such stock price data is produced which has been compressed in accordance with the pattern of the first classification and the pattern of the second classification (step S204).

Next, a decision is made as to whether the stock price data is sequentially transmitted every one stock name, or the stock price data of the plurality of stock names are transmitted in the batch mode (step S205). In the case that the stock price data is sequentially transmitted, the compressed stock price data of one stock name is immediately transmitted to the terminal unit (step S206). With respect to all of the stock price data to be transmitted, the process operations defined from the step S201 to the step S206 are repeatedly carried out (step S207). On the other hand, in such a case that the stock price data of the plural stock names are transmitted in the batch mode, the compressed stock price data are temporarily stored (step S208). This process operation is repeatedly carried out until the data compression processing operation is completed as to all of the stock price data to be transmitted (step S209). The compressed stock price data are rearranged with respect to each of the classifications based upon both the first classification information and the second classification information (step S201). Then, the rearranged stock price data are transmitted to the terminal unit in the batch mode (step S211).

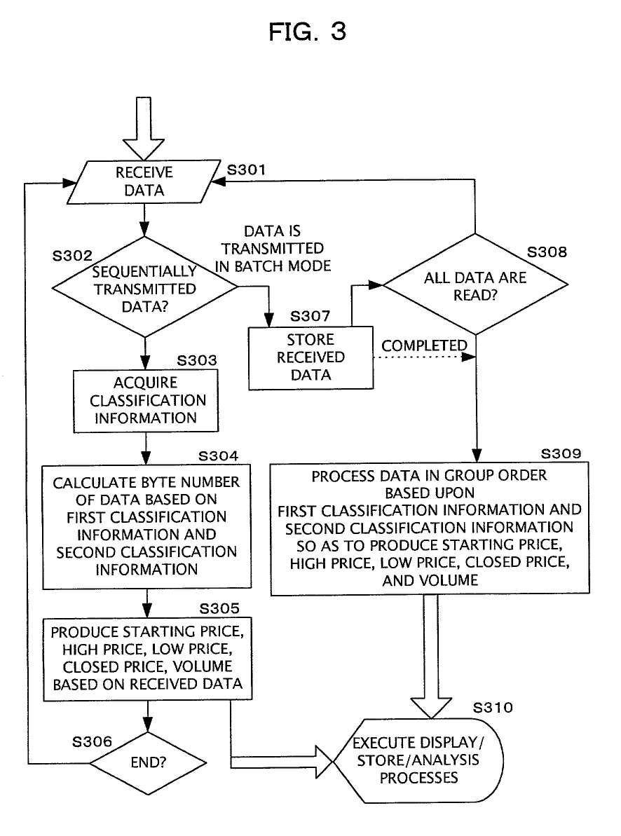

FIG. 3 is a flow chart showing a summary of an example of a processing operation executed in the case that the compression stock price data which has been compression-processed by way of the processing operation indicated in FIG. 2 and then is transmitted from the host computer is received by the terminal unit so as to be expanded.

Upon receipt of compressed stock price data (step S301), a judgement is made as to whether the received data corresponds to the sequentially transmitted data of every stock name, or the data of the plurality of stock names transmitted in the batch mode (step S302). When the sequentially transmitted data is received, classification information attached to this data is acquired (step S303). Based upon both the first classification information and the second classification information, a byte number of this sequentially transmitted data is calculated (step S304). Then, a starting price of the stock name, a high price thereof, a low price thereof, a closed price thereof, and also a dealing volume are produced from the received data (step S305). The above-described process operations are repeatedly carried out until the reception of the sequentially transmitted data is accomplished (step S306).

On the other hand, in the case that the received data corresponds to the data transmitted in the batch mode, the compressed data to be received is temporarily stored (step S307), and the process operation is repeatedly carried out until reading of all of the compressed data is accomplished (step S308). When reading of all of the compressed data is accomplished, the received data are processed in the group order based upon both the first classification information and the second classification information, so that starting prices of the plural stock names, high prices thereof, low prices thereof, and the stock dealing volumes thereof are produced(step S309).

The stock price data of the plural stock names, which have been expanded in the above-explained manner, may be displayed on a computer display of a terminal unit, may be stored in a hard disk unit, or may be immediately analysis-processed by way of a technical analysis, a chart analysis, and so on. That is, an arbitrary process operation based upon the normal stock price data may be carried out (step S310).

Now, a description will be made of such a concrete example that the compression method of the stock price data according to this embodiment has been applied to stock price data actually acquired on a certain day of October, 1999. In this concrete example, a total number of stock names for the stock price data used as a sample was selected to be 3459 firms. A portion of this sample was given as follows:

| security | stock | starting | high | low | closed | |
|---|---|---|---|---|---|---|
| code | name | price | price | price | price | volume |
| 1301, | AAA, | 143, | 147, | 143, | 144, | 136 |
| 1331, | AAB, | 184, | 188, | 183, | 185, | 330 |
| 1332, | AAC, | 215, | 226, | 210, | 226, | 743 |
| 1333, | AAD, | 120, | 123, | 119, | 120, | 211 |
| 1351, | AAE, | 103, | 108, | 103, | 107, | 24 |
| 1352, | AAF, | 126, | 126, | 125, | 126, | 8 |
| 1377, | AAG, | 2665, | 2695, | 2655, | 2655, | 38 |

When the stock price portions except for the security code and the stock name are handled as text data, 63272 bytes were required. Also, when the stock price portions are handled as binary data, 12 bytes×3459=41508 bytes were required. When the general-purpose 4-byte processing operation is carried out with respect to these stock price portions, 4 bytes×5×3495=69180 bytes were required.

In such a case that the compression method according to this embodiment is applied to an example of “1301, AAA”, the starting price is identical to the low price, the low price is smaller than, or equal to 256, and also a difference between the low price and each of the high price, the starting price, and the closed value is smaller than, or equal to 256, and furthermore, the stock dealing volume is smaller than, or equal to 256. As a consequence, patterns of the first classification and the second classification, to which this example belongs, are given as follows with reference to both the table 2 and the table 4, namely the first classification=8 and the second classification=1. As a consequence, while the low price=143 (1 byte), the high price=4 (1 byte), the closed price=1 (1 byte), and the volume=136 (1 byte), the classification identification data (1 byte) is added thereto to require 5 bytes in total.

Similarly, in another example of “1331, AAB”, patterns of the first classification and the second classification, to which this example belongs, are given as follows with reference to both the table 2 and the table 4, namely the first classification=13 and the second classification=2. As a consequence, while the low price=183 (1 bytes), the starting price=1 (1 byte), the high price=5 (1 byte), the closed price=2 (1 byte), and the volume=330 (2 bytes), the classification identification data (1 byte) is added thereto to require 6 bytes in total.

When the stock price portions (starting prices, high prices, low prices, closed prices, volumes) as to 3459 firms are compressed in accordance with the compression method of this embodiment, a total byte number was 7326 bytes. If the classification identification data (1 byte) is added, the required bytes were 7326+3459=10785 bytes.

Total sets of combination of the first classification information with the second classification information are made of 13×9=117 sets. As a result, when the compressed stock data are transmitted every group in accordance with the previously explained batch-mode transmission method, the classification identification data is no longer required to be added to each of the stock names, but may be applied to each of these groups. Therefore, if 3 bytes are set in order to separately add an identifier for this purpose, then 7326+ 117×3=7677 bytes are needed.

As previously explained, in the prior art method, approximately 60 KB (kilobytes) were required for text data, and approximately 45 KB to 70 KB were required for binary data. To the contrary, in the compression method according to this embodiment mode, the stock price data could be compressed by 8 KB to 11 KB. In other words, the data compression effect, which was approximately 4 times up to approximately 9 times (in maximum) higher than that of the conventional method, was acheived.

It should be understood that the stock price compression method according to the present invention does not exclude the combination use with other general-purpose data compression method. That is, for instance, since another data compression algorithm (e.g., LHA and ZIP) may be applied to the stock price data which is compressed in accordance with this stock price data compression method, in order to more compress the stock price data.

As previously explained in detail, in accordance with the compression method of the present invention, while the attention is paid to the stock dealing volume value and the relationship among the starting value, the high value, the low value, and the closed value, which may occur in the security trading, the two sorts of classifications are previously set, and also each of these two classifications is further previously subdivided into a plurality of patterns. Also, the classification identification data as to which pattern of the respective classifications is used to largely reduce a set of the stock price data belongs, the total byte number required to execute the process operation of the stock price data. There are many merits in the on-line trade which may be expectedly increased in near future. That is, loads given to host computers and also communication lines can be reduced, and also the transmission response as well as the reception response can be improved.

The preferred embodiment of the present invention has been disclosed by way of example and it will be understood that other modifications may occur to those skilled in the art without departing from the scope and the spirit of the appended claims.

What is claimed is:

1. A compression method of stock price data, wherein:
while two sorts of classifications are previously set based upon a volume of stock dealings and a relationship among values of a starting price, a high price, a low price, and a closed price, which may occur in security trading in a stock market, the first classification is previously subdivided into “n” sorts (symbol “n”<16) of patterns in accordance with a high/low/same value relationship among the starting price, the high price, the low price, and the closed price, and the second classification is previously subdivided into “m” sorts (symbol “m”<16) of patterns in accordance with the low price, a difference between the high price and the low price, the stock dealing volume, and a digit notation; the compression method comprising the steps of:
entering one piece of stock price data which contains at least numeral value data (S, H, L, E, T,) related to the starting price, the high price, the low price, the closed price, and the stock dealing volume;
identifying as to which pattern of the first classification said entered stock price data belongs to thereby producing first classification information indicative of said identified pattern;
identifying as to which pattern of the second classification said entered stock price data belongs to thereby producing second classification information indicative of said identified pattern;
combining said produced first classification information with said produced second classification information thereby producing one piece of classification identification data “C”;
extracting numeral data “L” of the low price from said stock price data;
producing numeral data D₁ of a difference between the starting price and the low price (D₁=S−L), numeral data D₂ of a difference between the high price and the low price (D₂=H−L), and numeral data D₃ of a difference between the closed price and the low price (D₃=E−L), based upon said stock price data; in the case that there are “K” pieces (symbol “K”=2, 3, or 4) of the same values among the numeral data as to the starting price, the high price, the low price, and the closed price, extracting (4−K) pieces of different numeral data “D₄” from the numeral data D₁, D₂, D₃;
extracting numeral data “T”, of the stock dealing volume from said stock price data; and
producing binary data related to stock price data of one stock name from said produced classification identification data “C”, said extracted numeral data “L” of the low price, said (4−K) pieces of different numeral data “D₄”, and the numeral data “T” of the stock dealing volume.

2. A transmission method of compressed stock price data, wherein:
while two sorts of classifications are previously set based upon a volume of stock dealings and a relationship among values of a starting price, a high price, a low price, and a closed price, which may occur insecurity trading in a stock market, the first classification is previously subdivided into “n” sorts (symbol “n”<16) of patterns in accordance with a high/low/same value relationship among the starting price, the high price, the low price, and the closed price, and the second classification is previously subdivided into “m” sorts (symbol “m”<16) of patterns in accordance with the low price, a difference between the high price and the low price, the stock dealing volume, and a digit notation; the transmission method comprising the steps of:
entering one piece of stock price data which contains at least numeral value data (S, H, L, E, T,) related to the starting price, the high price, the low price, the closed price, and the stock dealing volume;
identifying as to which pattern of the first classification said entered stock price data belongs to thereby producing first classification information indicative of said identified pattern;
identifying as to which pattern of the second classification said entered stock price data belongs to thereby producing second classification information indicative of said identified pattern;
combining said produced first classification information with said produced second classification information thereby producing one piece of classification identification data “C”;
extracting numeral data “L” of the low price from said stock price data;
producing numeral data D₁ of a difference between the starting price and the low price (D₁=S−L), numeral data D₂ of a difference between the high price and the low price (D₂=H−L), and numeral data D₃ of a difference between the closed price and the low price (D₃=E−L), based upon said stock price data, in the case that there are “K” pieces (symbol “K”=2, 3, or 4) of the same values among the numeral data as to the starting price, the high price, the low price, and the closed price, extracting (4−K) pieces of different numeral data “D₄” from the numeral data D₁, D₂, D₃;
extracting numeral data “T” of the stock dealing volume from said stock price data;
producing binary data related to stock price data of one stock name from said extracted numeral data “L” of the low price, said (4−K) pieces of different numeral data “D₄”, and the numeral data “T” of the stock dealing volume;
carrying out said data compression to the binary data with respect to stock price data of a plurality of stock names;
while said classification identification data “C” is used as a key, producing a plurality of groups of binary data having the same data from the compressed stock price data of the plurality of stock names;
adding the classification identification data “C” corresponding to said group to a head of each of said groups as binary data; and
transmitting said resulting binary data from a host computer via a communication line to at least one terminal unit in a batch mode.
